(19) United States
(12) Patent Application Publication
(10) Pub. No.: US 2011/0120936 A1
(43) Pub. Date: May 26, 2011

(54) Anti-Biofouling Materials and Methods of Making Same

(75) Inventors: Isabel C. Escobar, Ottawa Hills, OH (US); Tilak Gullinkala, Toledo, OH (US); Richard Hausman, Gibsonburg, OH (US)

(73) Assignee: UNIVERSITY OF TOLEDO, Toledo, OH (US)

(21) Appl. No.: 12/996,857

(22) PCT Filed: Jun. 10, 2009
(86) PCT No.: PCT/US09/46859

§ 371 Date: Dec. 22, 2010

Related U.S. Application Data
(60) Provisional application No. 61/061,099, filed on Jun. 12, 2008.

(51) Int. Cl. B01D 69/10; C08G 73/02; C08L 79/00; B32B 1/02; B01D 61/10

(52) U.S. Cl. 210/490; 525/361; 524/606; 428/34.1

(57) ABSTRACT

Anti-biofouling nanocomposite material at least partially loaded with copper or silver ions and methods for making same are disclosed. Metal affinity ligands are covalently bound to the polymers that are charged with the metal ions to allow for slow release of metals.

### CROSS-REFERENCE TO RELATED APPLICATIONS AND STATEMENT REGARDING SPONSORED RESEARCH

The present invention claims the benefit of U.S. Provisional Patent Application No. 61/061,099, filed Jun. 12, 2008, the disclosure of which is incorporated herein by reference in its entirety.

This invention was made with government support under Grant numbers NSF CBET 0714539 and NSF CBET 0754387. The government has certain rights in this invention.

### TECHNICAL FIELD AND INDUSTRIAL APPLICABILITY OF THE INVENTION

The present invention relates to the field of membrane filtration, and more specifically to anti-biofouling nanocomposite materials.

### BACKGROUND OF THE INVENTION

There is no admission that the background art disclosed in this section legally constitutes prior art.

Membrane technologies offer great promise to meet increasingly stringent regulatory requirements for potable water production. Membranes are capable of separating particulate material as a function of their physical and chemical properties when a driving force is applied, and they enable filtration for removal of suspended solids, colloids, biological cells and molecules and the like.

While other technologies can achieve similar treatment objectives, filtration systems using membranes offer notable advantages. For example, nanofiltration (NF) and reverse osmosis (RO) membranes have now made alternative water reclamation (i.e., brackish water and seawater) and wastewater reuse viable solutions to address the growing global scarcity of traditional water sources. The various filtration systems can be made in various configurations where membrane materials are typically adjacent to a support, or feed spacer, which forms a flow channel in the filtration system. Often, the feed spacers act both as a mechanical stabilizer for the flow channel geometry and as turbulence promoters within the filtration system.

The implementation of NF and RO processes in treating traditional water sources can provide a steady-state level of particulate material removal that eliminates the need for regeneration of such purification materials as ion exchange resins or granular activated carbon. Moreover, RO can help meet potable water demands through desalination of seawater and brackish waters.

Although NF and RO membrane filtration systems have not, in the past, been intended for disinfection, such membrane filtration systems can provide an additional barrier for virus and bacteria removal, which is essential for indirect potable, wastewater reuse.

While the use of a membrane filtration system is beneficial, various technical and cost issues remain to be addressed. Of these issues, the fouling of the membranes and the feed spacers in the filtration systems by particulate materials that are being filtered out of the feed source continues to demand considerable attention. The fouling adversely affects the membrane performance and cost through loss in flux, increase in pressure, and cleaning frequency.

Biofouling is a general term used to describe undesirable deposits of microbes, bacteria, yeast, cell debris or metabolic products that remain on the surfaces (e.g., membranes and/or feed spacer) within the filtration system. When biofouling occurs, the deposits are generally difficult to remove. The particulate materials causing the biofouling can grow and/or form colonies that grow into slime deposits on the membrane and/or feed spacers. The accumulation of these biofouling materials can cause the filtration systems to fail due to the buildup of increased pressure that consumes more energy, requires more cleaning, reduces flux and decreases recovery.

In particular, biofouling of the filtration systems in the treatment of water by RO membrane filtration is a significant problem. Biofouling reduces membrane performance and raises cost through loss in flux, increase in pressure, and cleaning frequency. Further, modifying the RO membranes themselves in an attempt to overcome biofouling is nearly impossible as the RO membranes must have specific compositions in order to maintain desirable properties.

At present, most research and development in the area of biofouling prevention has focused on such processes as pretreatment of the feed water, enhanced cleaning solutions, cleaning procedures, and replacement of the fouled membranes.

Since the success of any filtration system is limited to ensuring that the permeate collected from a feed source has a very high purity level (e.g., very low cell count) and that the filtration system can be cost effectively operated at a safe flow parameters, there is a need for an improved filtration system.

Likewise, it would be further desirable to develop anti-biofouling compositions that can also be used in other applications. Non-limiting examples of such end-use applications include food packaging, medical applications, textiles and the like.

### SUMMARY OF THE INVENTION

In one aspect, there is provided herein an anti-biofouling polymer reaction product, comprising an anti-biofouling reaction product comprising a reaction product of at least one polymer, at least one metal chelating ligand comprised of a spacer arm side chain having a reactive affinity group, and at least one chelated metal ion moiety. The reactive affinity group of the ligand is complexed with (and can be considered to be, chemically bound to) the chelated metal ion moiety.

In certain embodiments, the reaction product is formed as one or more of a: fiber, film or shaped article. Also, the reaction product can be dispersed as a coating.

In another aspect, there is provided herein an anti-biofouling reaction product for use in removing biocontaminants in a filtration system where the reactive moiety is capable of complexing with the metal ion and reacting with the biocontaminants.

In another aspect, there is provided herein a filtration system useful when screening or filtering fluids to decrease biocontaminants in the fluids. The filtration system includes an anti-biofouling reaction product comprised of a polymer, a metal chelating ligand comprised of a spacer arm side chain having a reactive affinity group, and a chelated metal ion moiety. The reaction product chelates the metal ion into a matrix with the chelate being incorporated into the matrix so that the filtration system can remove bio-fouling contaminants.

In another aspect, there is provided herein a filtration system of the type comprising a membrane and at least one feed spacer. At least one feed spacer is comprised of an anti-biofouling reaction product; anti-biofouling reaction product comprised of at least a polymer, a metal chelating ligand comprised of a spacer arm side chain having a reactive affinity group, and a chelated metal ion moiety. The anti-biofouling feed spacer increases the removal of biocontaminants while maintaining membrane performance.

In still other aspects, there is provided herein a filtration system comprising at least one filtration membrane, and one or more feed spacers comprised of, or coated with, an anti-biofouling reaction product for use in removing biocontaminants in a filtration system where the anti-biofouling reaction product comprised of at least a polymer, a metal chelating ligand comprised of a spacer arm side chain having a reactive affinity group, and a chelated metal ion moiety; and where the reactive moiety is capable of complexing with the metal ion and reacting with the biocontaminants.

In certain embodiments, the side chains are introduced as a spacer on a main chain of the polymer by a graft polymerization method. In certain embodiments, the spacer arm side chain has an epoxy ring as the reactive moiety.

In certain embodiments, the affinity group moiety comprises a metal chelating ligand. In certain embodiments, the metal chelating ligand comprises one or more of: a tridentate chelator such as iminodiacetic acid (IDA) and/or nitrilotriacetic acid; a metal chelating ligand specific to one or more of: copper and silver.

In certain embodiments, the polymer can be a polypropylene material, or other polymer that can readily accept the spacer arm side chains. In certain embodiments, the spacer arm side chain comprises a vinyl monomer with an epoxy ring as the reactive moiety, such as, but not limited to glycidyl methacrylate (GMA).

In certain embodiments, the vinyl monomer can be polymerized using an initiator and/or the vinyl monomer can be copolymerized with other vinyl groups. Also, in certain embodiments, the polymer comprises one or more of: a film material and fibers, including woven fibers and unwoven fibers.

In certain embodiments, the metal ions comprise one or more of: silver, copper, and mixtures thereof. For example, in one particular embodiment, the affinity moiety comprises iminodiacetic acid (IDA), the spacer arm side chain comprises glycidyl methacrylate (GMA), and the metal ions comprise copper ions.

In another broad aspect, there is provided herein other uses, devices and/or objects that are made of the anti-biofouling reaction products described herein. Non-limiting examples include using the anti-biofouling reaction products in filtration systems where the anti-biofouling reaction products are used to make feed spacers that are in a reverse osmosis filtration device.

In other non-limiting examples, the anti-biofouling reaction products can be used in liquid applications that require such plastics as polypropylene as a container, such as water storage, juice storage, wine storage, beer storage, among other liquids that would be stored in polypropylene containers.

In other non-limiting embodiments, the anti-biofouling reaction products can be used in applications where liquids would require an additional filtration step.

In other non-limiting embodiments, the anti-biofouling reaction products can be used to make, for example, containers, tubing, specimen containers, water bottles, bottle stoppers, petri dishes, etc., tubing/hoses used in purification, brewing, fermentation, etc.

In another broad aspect, there is provided herein a filtration device for reverse osmosis spiral wound elements comprised of the anti-biofouling reaction product as described herein.

In another broad aspect, there is provided herein a membrane system for biofouling control comprised of the anti-biofouling reaction product as described herein.

In another broad aspect, there is provided herein anti-biofouling reaction products having anti-biofouling copper metal ions chelated to affinity groups that are affixed to a spacer moiety, where the spacer moiety is grafted onto a polypropylene backbone.

In another broad aspect, there is provided herein a method for immobilized metal affinity based separations, comprising using a metal chelating ligand to attach anti-biofouling metal ions to a polymer backbone via a spacer arm.

In a broad aspect, there is provided herein a method for making an anti-biofouling polymer reaction product, comprising: grafting spacer arm side chains onto a polymer; introducing an affinity group moiety to a reactive moiety on the spacer arm side chain; and, chelating anti-biofouling metal ions to the affinity group moieties.

In certain embodiments, the graft polymerization of the spacer arm side chain to polymer occurs without melting of the polymer.

In certain embodiments, the graft polymerization of the spacer arm side chain to the polymer occurs at a temperature not greater than about 80° C.

In certain embodiments, the affinity group moiety is added via an S_{N}2 reaction.

In certain embodiments, the anti-biofouling metal ions are present in a copper sulfate solution or a copper chloride solution.

In certain embodiments, the anti-biofouling metal ion is in the form of an aqueous solution of a salt of the metal, comprising 0.25 to 15% w/w of the metal.

In certain embodiments, benzoyl peroxide is used as a radical initiator for graft polymerization of the spacer arm side chains to the polymer.

In another broad aspect, there is provided herein a method for making anti-biofouling nanocomposite material loaded with anti-biofouling metal ions, comprising controlling the degree of metal ion binding on a polymer through modification of metal affinity ligands bonded to spacer arm side chains on the polymer.

In another broad aspect, there is provided herein a method for making anti-biofouling nanocomposite material, further comprising:

using benzoyl peroxide (BPO) as a radical initiator for graft polymerization of glycidyl methacrylate (GMA) to the polypropylene at a temperature of about 80° C.;

adding iminodiacetic acid (IDA) to the polypropylene-graft-GMA via an SN2 reaction; and
placing the polypropylene-graft-GMA-IDA in a copper sulfate solution for chelation of the copper ions.

In certain embodiments, the polymer-graft-GMA-IDA film is exposed to a 0.2 M copper sulfate solution from about 20 minutes to about eight hours.

In another broad aspect, there is provided herein a method for making a functionalized polypropylene surface with metal affinity ligands, comprising: activating a polypropylene backbone with a radical initiator; reacting the polypropylene of step i) with a spacer arm side chain having a reactive moiety; iii) reacting the polypropylene of step ii) with a metal chelating affinity ligand; and iv) exposing the polypropylene of step iii) to a copper sulfate solution for chelation of copper ions.

In certain embodiments, the radical initiator comprises benzoyl peroxide. In certain embodiments, the spacer arm side chain comprises glycidyl methacrylate (GMA). In certain embodiments, the metal chelating affinity ligand comprises iminodiacetic acid (IDA). In certain embodiments, the polypropylene of step iii) is exposed to a 0.2 M copper sulfate solution for about eight hours.

In another broad aspect, there is provided herein a method of making polypropylene materials for reverse osmosis comprised of any of the methods of the preceding claims.

In still another broad aspect, there is provided herein feed spacers for reverse osmosis spiral wound elements comprised of fibers or films as in any of the preceding embodiments.

In a further broad aspect, there is provided herein a membrane system for biofouling control comprised of fibers or films as described herein.

Various objects and advantages of this invention will become apparent to those skilled in the art from the following detailed description of the preferred embodiment, when read in light of the accompanying drawings.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the Patent Office upon request and payment of the necessary fee.

FIG. 1 is a schematic illustration of an affinity group with a spacer arm.

FIG. 2 is a schematic illustration showing a spacer arm-metal ligand development (GMA+IDA).

FIG. 3 is a schematic illustration showing BPO radical development.

FIG. 4 is a schematic illustration showing a reaction between PP and GMA-IDA.

FIGS. 5A-5B are AFM images of PP-GMA-IDA (FIG. 5A), and pristine PP (FIG. 5B).

FIG. 6 is a schematic illustration showing copper loaded PP-GMA-IDA.

FIG. 7 is a schematic illustration showing nanocomposite silver loaded PP fibers.

FIG. 8 is a schematic illustration showing silver loaded PP-GMA-SA.

FIG. 9 is a schematic illustration of an exemplary reaction apparatus used in accordance with an Example disclosed herein.

FIG. 10 is an exemplary graph showing an ATR-FTIR spectrum of virgin PP and PP-graft-GMA films.

FIG. 11 is a schematic illustration of a chemical reaction between PP, BPO and GMA.

FIG. 12 is an exemplary graph showing an ATR-FTIR spectrum of virgin PP and PP-graft-GMA-IDA films.

FIGS. 13A-13F show various SEM images and EDS analysis of the even chelation of copper over a PP surface.

FIG. 14 shows exemplary images of a virgin PP sheet and a PP-graft-GMA-IDA sheet after being in 0.2 M Copper Sulfate solution for eight hours and repeatedly rinsed with DI water.

FIGS. 15A-15B shows a set of fluorescence microscope images of samples of cells taken after 24 hours of incubation from each E. coli containing flask representing biofilm growth on one PP-graft-GMA-IDA modified sheet and one virgin PP sheet.

FIG. 16 is an exemplary graph showing copper containing PP-graft-GMA-IDA sheets maintaining a cell attachment about an order of magnitude lower than on virgin PP sheets.

FIGS. 17A-17B are exemplary histograms showing the percentage of copper weight of copper charged PP-graft-GMA-IDA sheets after one week and two weeks in three solutions, representing both cleaning solutions and sources of metal salts that may displace the chelated copper.

FIG. 18 is an exemplary graph showing a comparison of filtration of the respective normalized fluxes of a virgin feed spacer membrane and that of a modified feed spacer membrane.

### DETAILED DESCRIPTION OF THE PREFERRED EMBODIMENT(S)

In broad aspects, there are provided herein reaction products and methods for addressing microbial fouling, or biofouling, of membrane surfaces and/or the feed spacers supporting the membranes.

It is to be understood that in reverse osmosis (RO) filtration systems, one or more feed spacers are present between sheets or envelopes of filtration membranes. For example, in certain types of spiral wound RO systems, the membrane is folded over a polypropylene spacer that is attached to a center tube.

In one aspect, there is provided herein anti-biofouling nanocomposite polymers loaded with anti-biofouling metal ions. It is to be understood that, when the polymer being used is in a pre-formed state, such as a shaped article, film or fibers (woven, nonwoven, etc.), only the outer surfaces of such polymers can have the metal ions covalently bonded thereto.

In a particular aspect, metal affinity ligands are covalently bound to the polymer. The metal affinity ligands can be charged with anti-biofouling metal ions to allow for slow release of the metal ions into the feedwater for biofouling control. In certain embodiments, the polymers can be nanostructured with metal affinity ligands specific to particular metal ions such as copper and silver. The metal chelating ligands are covalently bound to the polymer via a spacer arm.

In another aspect, there is provided herein a method for making anti-biofouling nanocomposite polymeric materials loaded with copper or silver ions. The method includes controlling the degree of copper/silver binding on organic fibers through modification of an initial metal affinity ligand.

In the formulation of such anti-biofouling reaction products, an affinity group that is comprised of a metal chelating ligand donates unshared electrons to the metal ion to form metal-ligand bonds. In a particular embodiment, a multidentate ligand, such as iminodiacetic acid (IDA), which possesses one aminopolycarboxylate, provides a reactive secondary amine hydrogen to react with alternate functional groups.

The polymer ligand can be indirectly attached to the polymer through the use of “spacer arm” side chains that are attached to the polymer. Again, in the case of pre-formed articles made of the polymer, the spacer arm side chains can be affixed to the polymer molecules that make up outer surfaces of the article.

The use of the spacer arm side chains allows the metal chelating ligand to be more readily exposed and configured for accepting/bonding the metal ions. For example, the chelating ligand can be affixed to side chains that have a reactive moiety. In one example, IDA can be affixed to a polymer backbone or vinyl monomer via an epoxy group reaction of a spacer arm side chain such as glycidyl methacrylate (GMA). This reaction has several advantages: (1) GMA is a commercial industrial material that is less expensive than most other vinyl monomers; (2) GMA possess an epoxy ring as a reactive moiety in the side chain; and (3) GMA produces a vinyl monomer that can be polymerized by the addition of initiators or copolymerized with other vinyl groups.

Benzoyl peroxide (BPO) can be used as a radical initiator for the graft polymerization of GMA onto a surface of the polymer films. In one embodiment, the graft polymerization of GMA to the polymer film surface can occur at a temperature of about 80° C. IDA is then added to the polymer-graft-GMA complex via an S_{N}2 reaction. The polymer-graft-GMA-IDA is then exposed to a copper sulfate solution for chelation of copper ions.

In another embodiment, the polymer-graft-GMA complex can be sequentially exposed to a ring-opening moiety, such as sodium sulfide (Na₂SO₃), hydrogen sulfate (H₂SO₄), and silver nitrate (AgNO₃), to affix silver ions to the GMA spacer arm side chain.

The present invention is further defined in the following Examples, in which all parts and percentages are by weight and degrees are Celsius, unless otherwise stated. It should be understood that these Examples, while indicating preferred embodiments of the invention, are given by way of illustration only. From the discussion herein and these Examples, one skilled in the art can ascertain the essential characteristics of this invention, and without departing from the spirit and scope thereof, can make various changes and modifications of the invention to adapt it to various usages and conditions. All publications, including patents and non-patent literature, referred to in this specification are expressly incorporated by reference herein.

### EXAMPLES

### Example 1

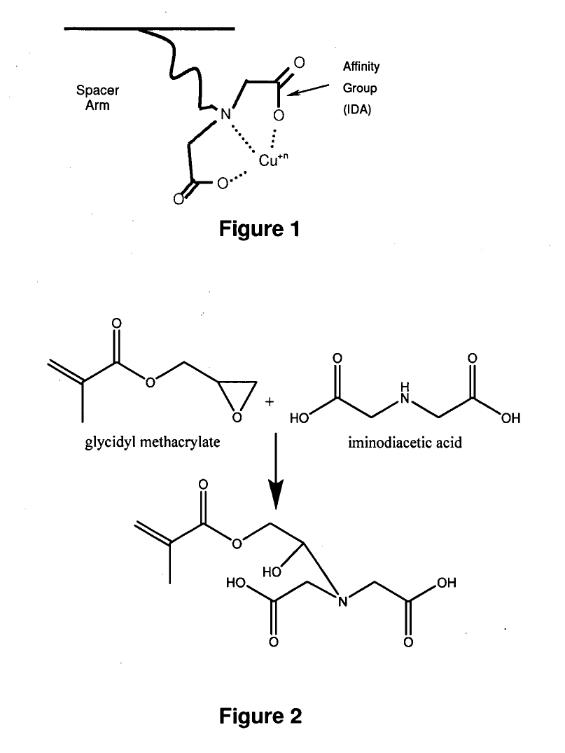

For immobilized metal affinity (IMA) based separations, a metal chelating affinity group is used to fix anti-biofouling metal ions to a backbone via a spacer arm side chain, as schematically illustrated in FIG. 1. The chelating ligands are bound to the polymer via a spacer arm to make the chelating group more accessible.

Useful metal chelating affinity groups are strong Lewis acids that form several coordinate bonds with the metal ion through the sharing of three or more pairs of electrons.

Iminodiacetic acid (IDA) can be employed as a metal chelating affinity group since this tridentate chelator, as well as the chemistry used to prepare the metal affinity media, is straightforward and reliable. IDA also provides a balance between the strong binding of the metal ion to the chelate and the protein affinity. It is to be understood that other chelating groups, such as nitrilotriacetic acid, can be utilized to moderate the relative metal-polymer affinity.

To affix a silver ion, the polymer can be nanostructured using a radical initiator, BPO, and a spacer arm, GMA. Two methods can be tested for loading of silver ions: (1) the GMA epoxy groups are converted to SO₃H groups, which are then loaded with silver ions; and (2) IDA is used as a chelating ligand in a similar manner to copper ions.

### Example 1a. Copper Ions

GMA+IDA Complex (FIG. 2)

Before the reaction of GMA and IDA, GMA is distilled under vacuum, while IDA is neutralized with KOH to form a dipotassium salt of IDA, and to keep carboxylic acid from reacting with the epoxy ring of GMA.

Dipotassium salt of IDA solution is added slowly to GMA at a 1:1 molar ratio under powerful stiffing for 12 hours at 65° C. and Na₂CO₃ to adjust the pH to 10-11. The resultant GMA-IDA complex particles are centrifuged.

PP+BPO+GMA-IDA

The polypropylene (PP) grafting process follows two steps: (1) soaking by GMA-IDA complex particles and the initiator (BPO), and (2) thermal-induced grafting. Grafting is confirmed by FTIR with appearance of peaks at 1725 cm⁻¹ (C═O) and 1640 cm⁻¹ (COO⁻¹).

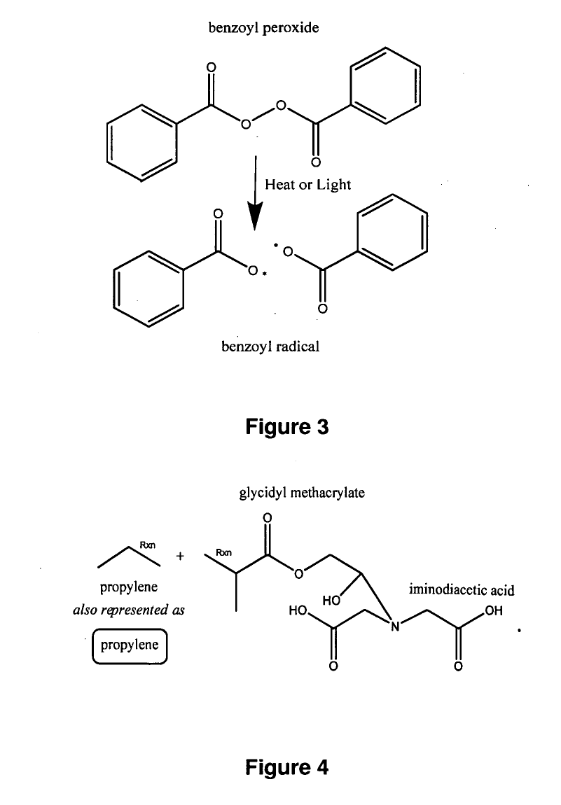

Benzoyl peroxide (BPO) decomposes into benzoyl radicals, which in turn undergo CO₂ elimination resulting in the formation of phenyl radical, as shown in FIG. 3.

Both phenyl and benzoyl radicals are good hydrogen abstractors. The formation of a phenyl radical from benzoyl radical depends on the temperature of the reaction. This reaction was conducted at different temperatures from 35°-90° C. to determine which, between benzoyl and phenyl radicals, is more effective in the radical development of PP.

In the method disclosed herein, a PP sheet is placed in a reaction ampoule with a chosen amount of a liquid mixture of BPO. GMA-IDA and toluene (interfacial agent) are introduced at room temperature for one hour in order for the mixture to be absorbed by the PP sheet. The wet heterogeneous mixture is then heated to an appropriate temperature and allowed to react for 15-90 minutes.

Nanostructured PP sheets (FIG. 4) are then dissolved in refluxing toluene to remove the homopolymer of GMA, which might be formed during the graft polymerization of PP sheets. The product sheets are then dried at 60° C. under vacuum.

Influential factors:

The reactions described herein have many influential factors. The performance of the initiator, BPO, depends on the nature of the monomer being attached, and the monomer to PP ratio. Though temperatures are kept below the melting point of PP to facilitate solid state grafting of PP, high temperatures may lead to unnecessary scission and cross linking reactions in the PP network.

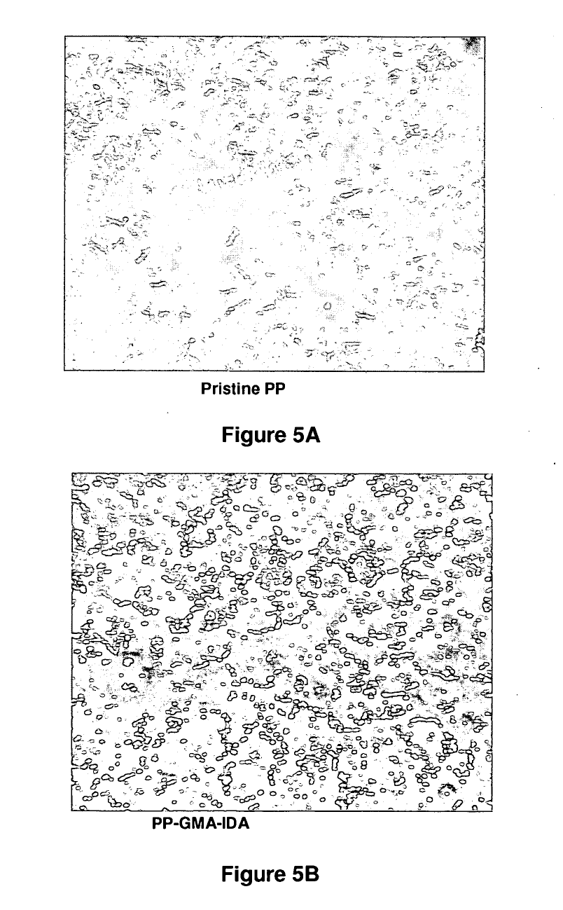

The initial vacuum distillation of GMA allowed for the GMA-IDA reaction to occur. While non-chemical radical initiators for PP, specifically irradiation and plasma treatment, were found to be highly effective, they were not cost effective. Further, scission and cross linking reactions in the PP sheet were problems because the temperature increase was high. Overall, BPO was found to be a very most cost-effective and controllable method of radical development. FIGS. 5A and 5B show the FTIR of the PP sheet (FIG. 5B), as well as the PP-GMA-IDA nanocomposite (FIG. 5A), that were developed using BPO for radical development.

The absorption peaks of the pristine PP are respectively assigned as follows; —CH stretching vibrations at 2840 to ˜3000 cm⁻¹ and the asymmetric and symmetric stretching of —CH in PP at 1375 and 1450 cm⁻¹. After the grafting of the GMA-IDA polymer, the absorption band at 1725 cm⁻¹ is caused by the stretching vibrations of the ester carbonyl groups and the strong band at 1633 cm⁻¹ is associated with the asymmetric stretching of C═O in carboxylate salts.

The atomic force microscope (AFM) images in FIGS. 5A and 5B are the pristine PP and the PP-co-GMA-IDA polymers, respectively. AFM was used to examine the surface morphology of modification. The PP-GMA-IDA AFM image (FIG. 5A) shows that a layer of grafted GMA-IDA polymer has partially covered the pristine PP polymer. While coverage is mostly uniform over the surface, clusters of GMA-IDA are observed. The homogeneity of GMA-IDA coverage is believed to be a function of reaction time, and different times will be studied to determine optimal surface coverage.

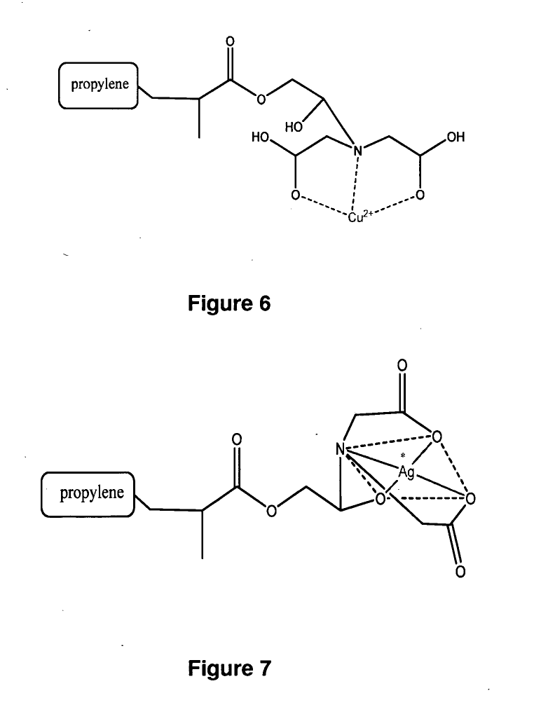

P-co-GMA-IDA+Copper (FIG. 6)

The PP-co-GMA-IDA complex can be further reacted with copper(II), CuSO₄, at a 1:1 ratio. The complexes are shaken at room temperature for 48 hours, washed with DI water, and dried under vacuum at 60° C. for two hours.

### Example 1b. Silver Ions

Two different methods were used for silver ions: (i) using an affinity group method; and (ii) using a sulfonation method.

(i) Affinity Group Method (IDA)

The PP grafting process follows the exact same steps as previously described in FIGS. 2-4. The difference arises for the metal loading.

The PP-GMA-IDA polymer is immersed in silver, Ag⁺¹, solution to chelate silver ions until equilibrium. Equilibrium is reached at a maximum adsorbed concentration of Ag⁺ on the PP-GMA-IDA fiber of 18 mg of Ag⁺/g fiber.

Finally, the silver loaded PP-GMA-IDA fibers are reduced by UV light with a wavelength of 366 nm and through immersion in formaldehyde solution to form the nanocomposite fibers shown in FIG. 7.

(ii) Sulfonation Method

The PP grafting process follows the same steps as for copper with the exception that no IDA is added to GMA. Therefore, the process follows: (1) soaking by GMA and the initiator (BPO), and (2) thermal-induced grafting. Sulfonation of the resultant epoxy group is achieved by immersing the PP-GMA in a mixture of sodium sulfite (Na₂SO₃)/isopropyl alcohol/water=10/15/75 (weight ratio) at 80° C. Any remaining epoxy groups are converted to diols by immersing in 0.5 M H₂SO₄. The resultant polymer is referred to as an SA fabric, where SA designates the sulfonic acid group.

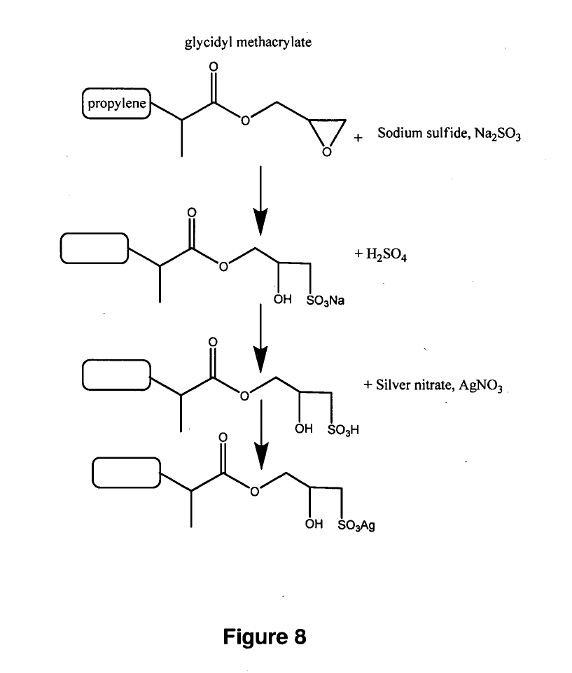

Silver ions are then loaded onto the PP-GMA-SA polymer by immersing it in a 0.1 M aqueous solution of silver nitrate (AgNO₃) with an excess of Ag ions with respect to SO₃H groups at 30° C. for 24 hours. The process is shown in FIG. 8.

### Example 2

The development of low biofouling PP films through the functionalization of PP by a spacer arm with metal chelating ligands charged with copper ions is disclosed. E. coli was used to measure the low-biofouling properties of the modified PP.

Materials

PP were obtained from Professional Plastics, Houston, Tex.. GMA was purchased from Fisher Scientific and vacuum distilled before use. Sodium iminodiacetate dibasic (IDA) hydrate 98% was purchased from Aldrich Chemistry and used as received. BPO, toluene, acetone, and copper sulfate also can be used as received.

Preparation and Characterization of Cu(II) Charged PP-graft-GMA-IDA

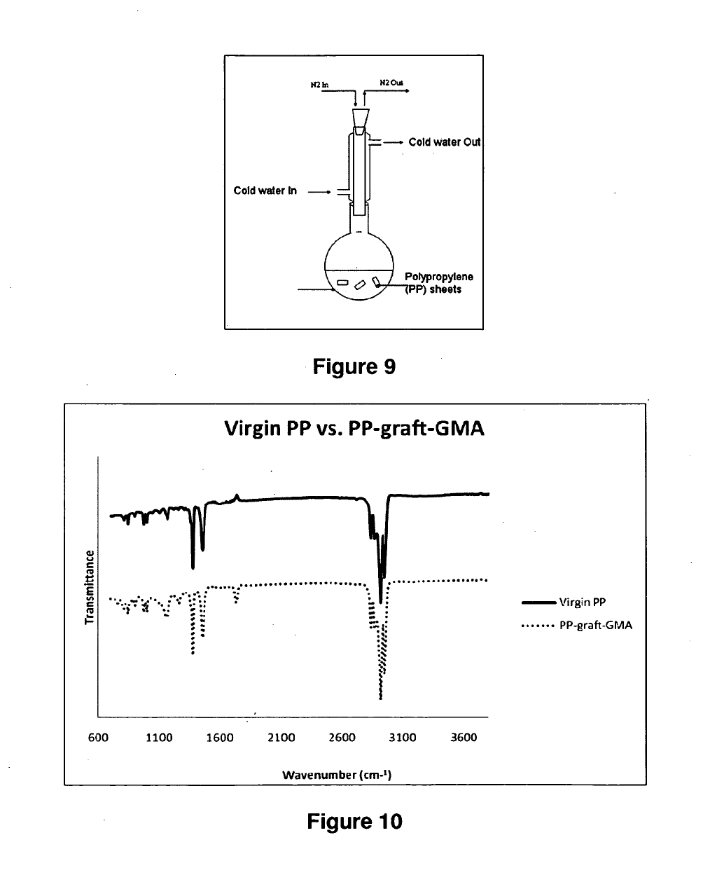

PP sheets were cut into squares with an area ranging from 2 cm² to 4 cm² and sonicated in ethanol to clean and remove anything on their surfaces. The sheets were then vacuum-dried at 60° C. for 24 hours. A schematic illustration of the reaction apparatus is show in FIG. 9. The reaction apparatus includes a round bottom flask, a condenser, and heating the reaction mixture, under a nitrogen atmosphere.

The initial weights (W_{O}) of the PP sheets were determined before they were placed in a round bottom flask containing toluene as a solvent/interfacial agent, the radical initiator BPO, and GMA. GMA and BPO were used as grafting initiators for PP. Polymerization occurred via a C—C double bond cleavage and resulted in a graft material with the original reactivity of the epoxy ring. Thus, the epoxy group can be effectively used to anchor the desired metal ion species.

After the sheets were soaked in the solution, the reaction vessel was purged with nitrogen and the temperature was increased to 80° C. and the grafting of GMA to PP was allowed to occur. The sheets were then taken out and washed with acetone to remove all GMA homopolymer. To confirm the grafting of GMA to the PP, the sheets were dried at 60° C. for 24 hours and analyzed by an attenuated total reflection Fourier transform infrared spectrometer (ATR-FTIR, Digilab UMA 600 FT-IT microscope with a Pike HATR adapter and an Excalibur FTS 400 spectrometer). The weights of the sheets were also determined at this time (W_{f}). The grafting level (GL%) of GMA onto PP was determined by using the following relation:

$$GL \% = \frac{{W}_{f} - {W}_{o}}{{W}_{o}} \times 100$$

The sheets were then placed into an IDA solution. After the reaction with IDA, deionized water (DI) water was used to rinse the sheets before they were vacuum dried and again analyzed by an ATR-FTIR spectrometer. The PP-graft-GMA-IDA sheets were placed into a copper sulfate solution to allow IDA to chelate Cu(II) ions. The presence of copper was detected using x-ray energy dispersive spectrometry (XEDS, UTW Si-Li Solid State X-ray detector with integrated EDAX Phoenix XEDS system, located at the University of Michigan, Ann Arbor).

Low-Biofouling Analysis of Cu(II) Charged PP-graft-GMA-IDA

Two 150 mL Erlenmeyer flasks of LB Broth (Difco/Becton, Dickinson and Company, Sparks, Md.) containing E. coli bacterium cells at a concentration of 3.0×10⁵ cells/mL were prepared. Three sheets of both virgin PP and Cu(II) charged PP-graft-GMA-IDA were added to each flask and then incubated at 35° C. At 24 hours, 96 hours, and 168 hours, sheets were taken from each flask. Cells were detached from the sheets using a Stomacher 400 Circulator (Seward Ltd, London, England). Detached cells were stained with Quant-iT PicoGreen dsDNA stain and counted using an Olympus BX51 fluorescent microscope and an Olympus DP-70 digital camera. Triplets of each sample were taken, counting ten fields each time.

Release of Copper Ions from Chelating Ligand

100 mL of DI water was added to three 150 mL Erlenmeyer flasks. To one flask, 2.67 g of NaCl, 0.267 g of MgCl and 0.267 g of CaCl₂ were added. Another was prepared to contain 5 mM EDTA at a pH of 11 (adjusted with NaOH). The final flask has its pH adjusted to 3.5 with HCl.

Three Cu(II) charged PP-graft-GMA-IDA modified sheets were added to each flask and placed on a shaker table. After one week, two weeks, and three weeks, one sheet was removed from each solution, washed with DI water, vacuum dried overnight and analyzed using XEDS. Four areas were analyzed per sheet and compared to a modified sheet that was not placed in any solution after its initial modification.

Results:

Preparation and Characterization of Cu(II) Charged PP-graft-GMA-IDA

The Example described herein focused on the functionalization of the PP sheets via a spacer arm with metal chelating ligands because these groups (i) are quite stable and easily synthesized, (ii) operate over a diverse range of conditions, (iii) have easily controlled binding affinities, and (iv) are well suited for model studies.

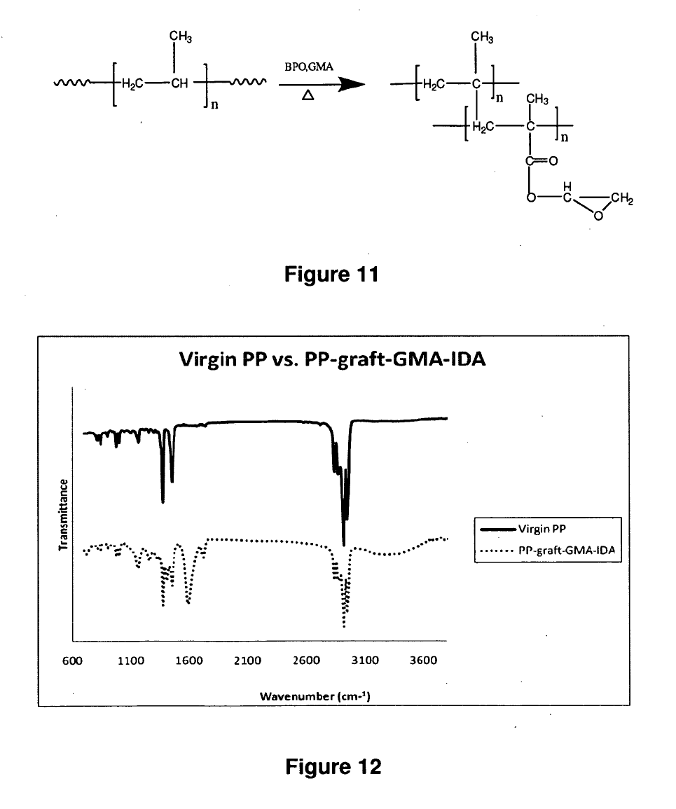

In the Example described herein, BPO is used as a radical initiator for the graft polymerization of GMA to the PP surface at a temperature of 80° C., or nearly half of temperatures outlined in the literature. FIG. 10 displays the ATR-FTIR spectrum of a PP-graft-GMA sheet. The adsorption bands present at 1724 and 1253 cm⁻¹ are caused by carbonyl stretching and ester vibrations of the epoxy group, respectively, indicating the attachment of GMA. This chemical reaction is shown in FIG. 11.

Then, via an S_{N}2 reaction, IDA was added to the PP-graft-GMA. The mean grafting level (GL%) for all of the sheets was approximately 40%; that is, over 3-4 times higher than those associated with other studies. Previous studies have shown that the use of PP powder or granules with a reaction temperature of 100-140° C. yielded ˜7% grafting. Another study showed that for radical development, soaking of PP films with GMA and BPO in supercritical CO₂ for 10 h and 130 bar at 70° C. followed by thermal-induced grafting at 120° C. yielded only 13.8% grafting. While not wishing to be bound by theory, the inventors herein now believe that the high level of grafting observed in this Example was due to uncontrolled radically initiated polymerization with high concentration of GMA monomer.

FIG. 12 displays the ATR-FTIR spectrum of PP-graft-GMA-IDA. Adsorptions at 1589 and 3371 cm⁻¹ are caused by carbonyl stretching from carboxylic acids and OH stretching from carboxylic acids present in IDA, respectively. The chemical reaction involved is shown in FIG. 4.

The virgin PP sheet and the PP-graft-GMA-IDA sheet were placed in a 0.2 M copper sulfate solution for eight hours. At the end of eight hours, the sheets were repeatedly rinsed with DI water. After exposure to copper sulfate (reaction shown in FIG. 6), XEDS analysis was performed on the sheets, which showed that there was 3.27 ±0.74%, by weight, copper loading on the surface.

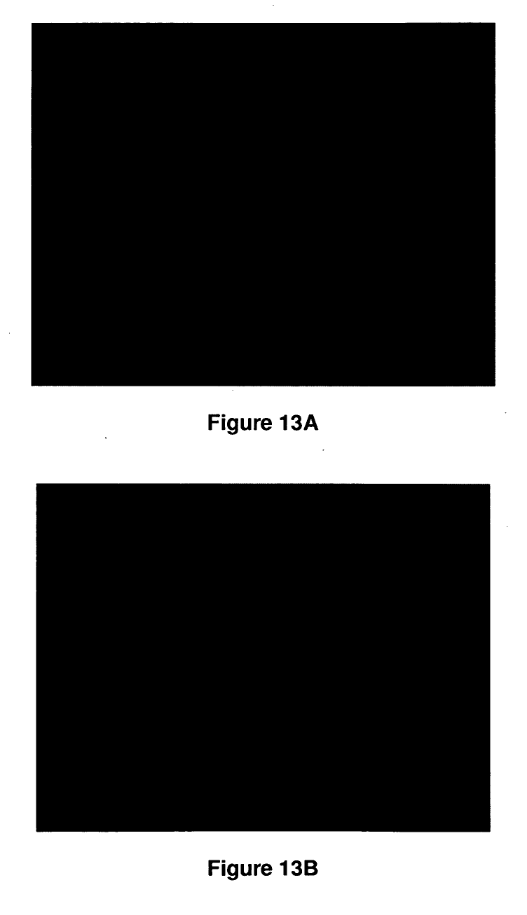

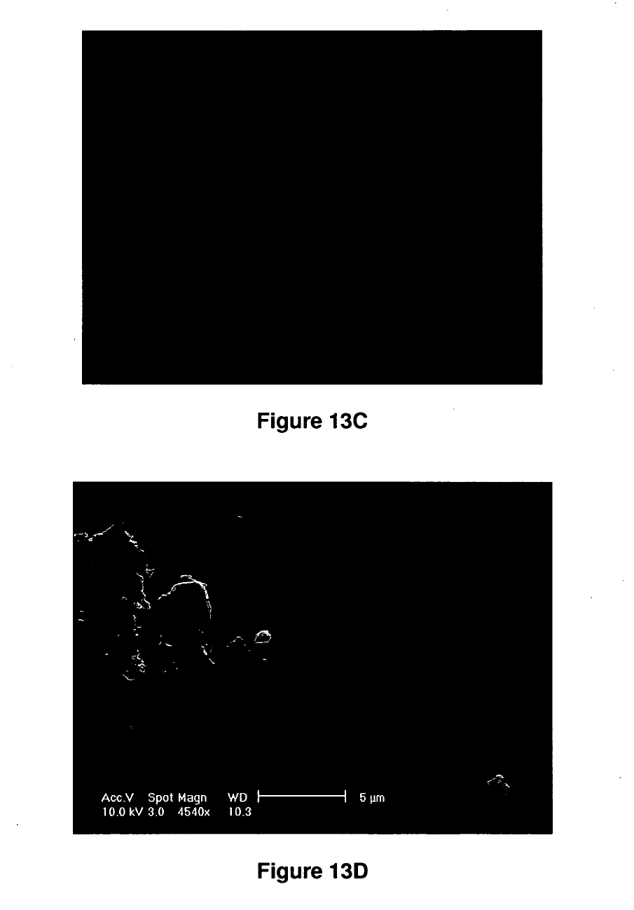

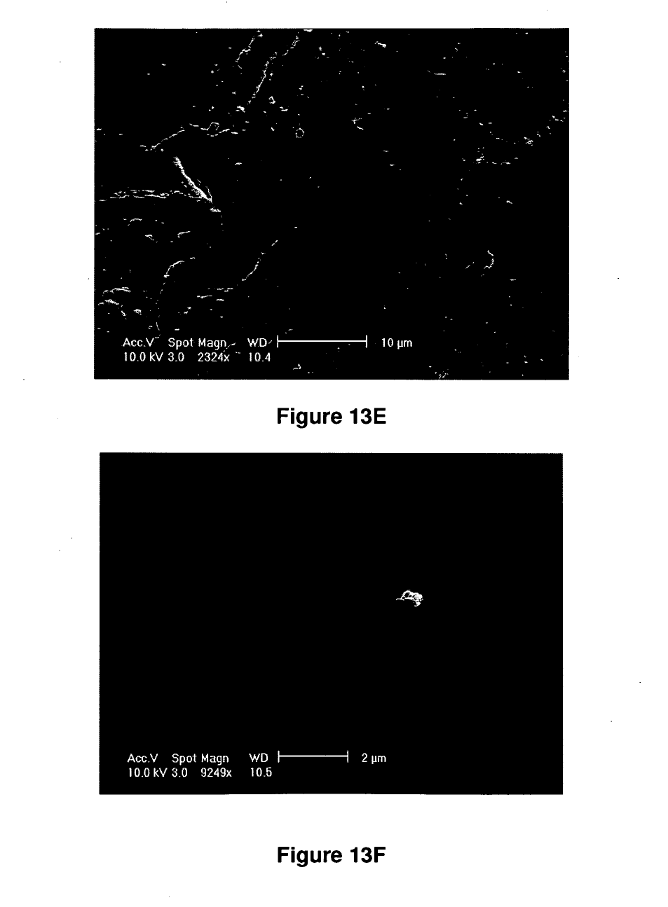

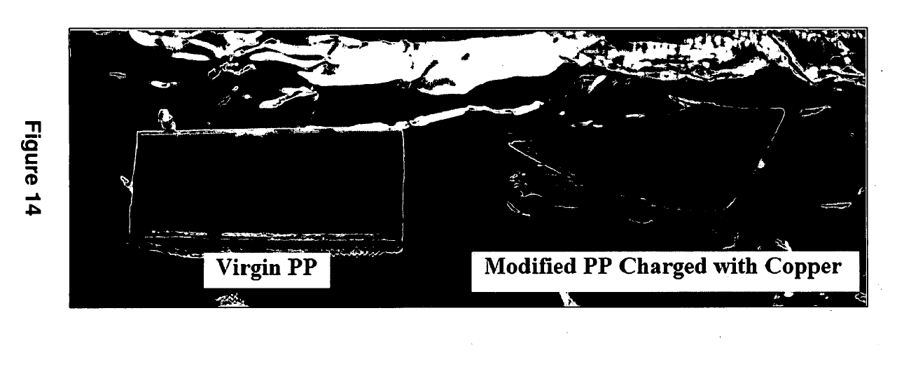

Also, as FIGS. 13A-13F show, mapping of the copper indicated uniform distribution over the surface of the sheets despite visual physical abnormalities present in SEM images (FIGS. 13A-13C). A visual inspection of the sheets gave a clear indication that copper is chelated to the PP-graft-GMA-IDA (FIGS. 13D-13F).

As seen in FIG. 14, the PP-graft-GMA-IDA sheet turned blue (shown as darkened in black+white photographs) when exposed to the copper sulfate solution while a virgin PP sheet exposed to the same solution retained its original color (slightly opaque/white).

Biofouling Analysis of Cu(II) Charged PP-graft-GMA-IDA

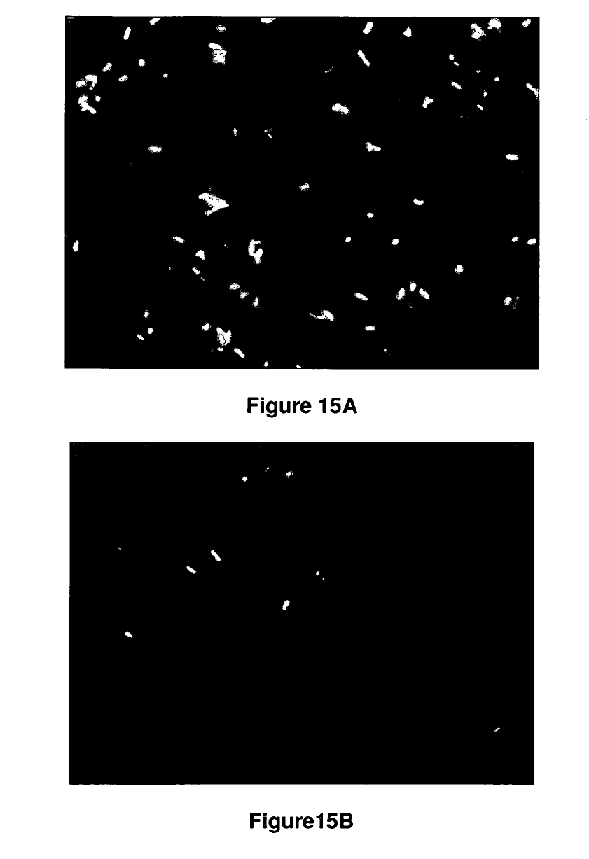

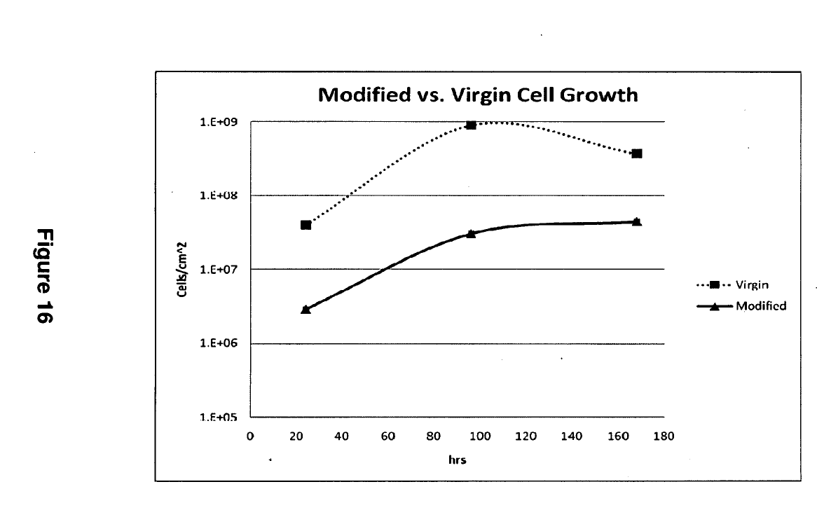

FIGS. 15A-15B show two of the fluorescence microscope photographs taken after 24 hours of incubation from each E. coli containing flask. For each sheet removed at the different time intervals, thirty of these images were taken. The number of cells attached to the PP-graft-GMA-IDA sheet after 24 hours was significantly less than those attached to the virgin PP sheets.

FIG. 16 shows the data collected over the entire 168 hours, including standard deviations for each point. After 24 hours, attachment was 2.9×10⁶±2.9×10⁵ cells/cm² on the PP-graft-GMA-IDA modified sheet versus 4.0×10⁷±2.1×10⁶ cells/cm² on the virgin PP sheet.

Similar results were obtained at 96 hours, 3.1×10⁷±2.2×10⁵ cells/cm² on the PP-graft-GMA-IDA modified sheets; and 9.1×10⁸±3.9×10⁶ on the virgin PP sheets.

The results at 168 hours were 4.5×10⁷±4.9×10⁴ on the PP-graft-GMA-IDA modified sheets; and 3.7×10⁸±1.1×10⁵ on the virgin PP sheets.

As can be seen, the number of cells attached to the PP-graft-GMA-IDA modified sheets was consistently approximately an order of magnitude lower than those attached to the virgin PP sheets.

Release of Copper Ions from Chelating Ligand

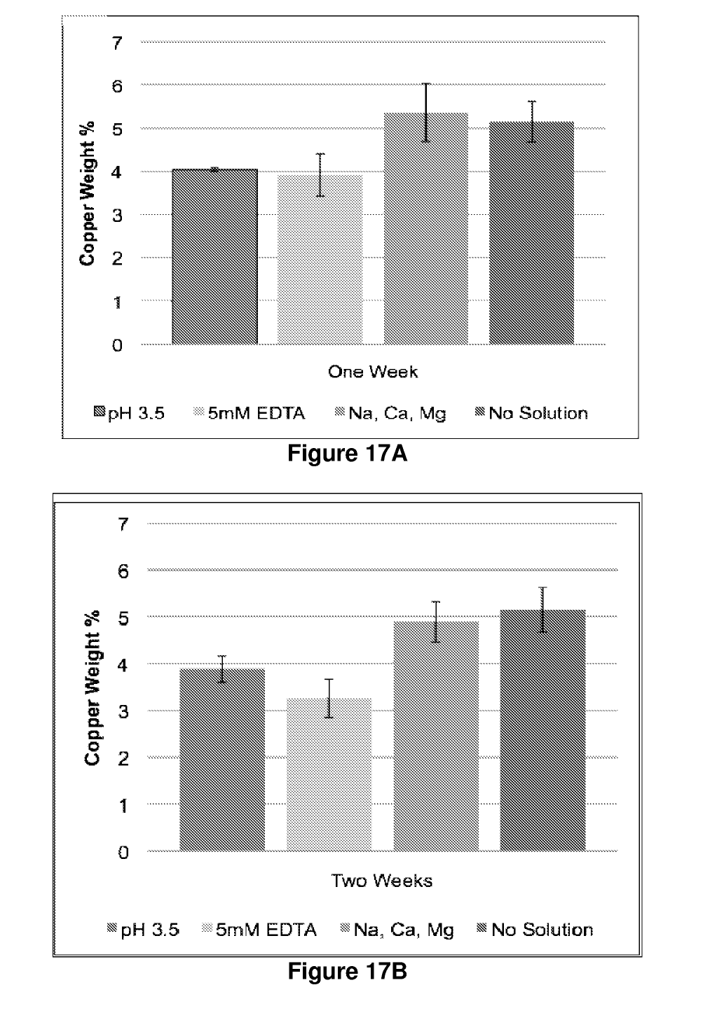

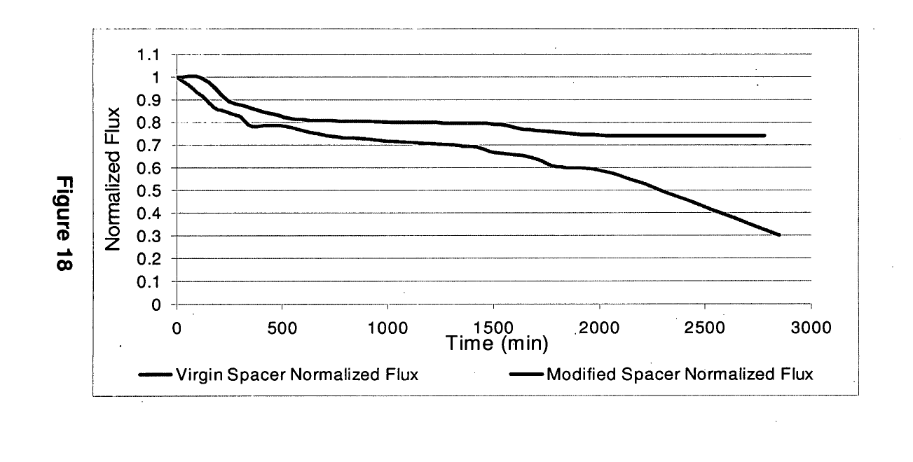

FIGS. 17A-17B show that the release of copper after two weeks in concentrated common cleaning solutions was not significant. The two instances where a significantly different weight percentage of copper was observed was after two weeks exposure to a 5 mM EDTA solution at pH 11; and exposure to a HCl solution at pH 3.5 after both one and two weeks. The data collected indicates that common metal ions such as sodium, calcium, and magnesium, do not displace the chelated copper. While the highly acidic solution and 5 mM EDTA did appear to have some affect on the PP-graft-GMA-IDA modified sheets after two weeks, the weight percent of copper remaining on the sheets after exposure was 3.26%±0.41 and 3.89±0.28 for the HCl and EDTA solutions, respectively. Even at these weight percents, the copper still acts effectively as a biocide.

It is to be noted that the infrared spectroscopy verified that PP was sufficiently modified to become PP-graft-GMA-IDA at temperatures of about 80° C., as opposed to either higher temperatures or harsher conditions proposed in other studies.

Also, the SEM and elemental analysis showed that the PP-graft-GMA-IDA modified materials were uniformly charged with copper(II). As now described herein, this modification method utilizes a readily assemble reaction apparatus, inexpensive and straightforward formulation techniques, and readily available chemicals.

The biofouling analysis showed that the number of cells attached to virgin PP sheets, over a 168 hour time span, was approximately an order of magnitude higher than those attached to the copper(II) charged PP-graft-GMA-IDA modified sheets. This shows that the metal-ion-charged polymer-graft-materials are useful for various applications, such as food packaging, medical devices, and RO feed spacers, and can increase performance and longevity while ultimately decreasing cost for such end-use applications.

### Example 3

FIG. 18 shows a comparison of filtration of the normalized flux between an unmodified feed spacer membrane and a charged PP-graft-GMA-IDA modified feed spacer membrane over a period of time from zero to 3000 minutes. The charged PP-graft-GMA-IDA modified feed spacer had approximately twice the normalized flux as the virgin feed spacer.

While the invention has been described with reference to various and preferred embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof.

Therefore, it is intended that the invention not be limited to the particular embodiment disclosed herein contemplated for carrying out this invention, but that the invention will include all embodiments falling within the scope of the claims.

### REFERENCES

The publication and other material used herein to illuminate the invention or provide additional details respecting the practice of the invention, are incorporated by reference herein, and for convenience are provided in the following bibliography.

Citation of any of the documents recited herein is not intended as an admission that any of the foregoing is pertinent prior art. All statements as to the date or representation as to the contents of these documents is based on the information available to the applicant and does not constitute any admission as to the correctness of the dates or contents of these documents.
1. Pan Y., Ruan J., Zhou D. (1997) Solid-Phase Grafting of Glycidyl Methacrylate onto Polypropylene. Journal of Applied Polymer Science, 65:1905-1912.
2. Badrossamy M., Sun G. (2008) Preparation of rechargeable biocidal polypropylene by reactive extrusion with diallylamino triazine. European Polymer Journal 44:733-742.
3. Cornelissen E. R., J. S. Vrouwenvelder, S. G. J. Heijman, X. D. Viallefont, D. Van der Kooij, and L. P. Wessels (2007). Periodic air/water cleaning for control of biofouling in spiral wound membrane elements. Journal of Membrane Science, 287:94-101.
4. Picchioni F., J. Goossens, and M. Duln (2001). Solid-state modification of polypropylene (PP): grafting of styrene on atactic PP. Macromol. Symp., 176:245-263.
5. Chen C-Y, and C-Y Chen (2002). Stability constants of polymer-bound iminodiacetate-type chelating agents with some transition-metal ions. Journal of Applied Polymer Science, 86:1986-1994.
6. Kim B., J. Anderson, S. Mueller, W. Gaines, and A. Kendall (2002). Literature Review—efficacy of various disinfectants against Legionella in water systems. Water Research, 36:4433-4444.
7. Landeen, L. K., Moyasar, M. T. and Gerba, C. P. 1989 Efficacy of copper and silver ions and reduced levels of free chlorine in inactivation of Legionella pneumophila. Appl. Environ. Microbiol. 55:3045-3050.
8. Beitle, R. R., and M. M. Ataai (1992). Immobilized Metal Affinity Chromatography and Related Techniques, in New Developments in Biosepartions, M. Ataai and S. Sikdar, Ed., AICHE, NY, 34-44.
9. Zachariou, M. (1996). Potentiometric Investigations into the Acid-Base and Metal Ion Binding Properties of Metal Ion Affinity Chromatographic Adsorbents, J. Phys. Chem., 100:12680-12690.
10. Kunita M. H., A. W. Rinaldi, E. M. Girotto, E. Radovanovic, E. C. Muniz, and A. F. Rubira (2005). Grafting of glycidyl methacrylate onto polypropylene using supercritical carbon dioxide. European Polymer Journal, 41:2176-2182.
11. Qian Yang, Meng-Xin Hu, Zheng-Wei Dai, Jing Tian, and Zhi-Kang Xu (2006). Fabrication of Glycosylated Surface on Polymer Membrane by UV-Induced Graft Polymerization for Lectin Recognition. Langmuir, 22:9345-9349.
12. Huiliang Wang, Hugh R. Brown (2006) Atomic force microscopy study of the photografting of glycidyl methacrylate onto HDPE and the microstructure of the grafted chains. Polymer, 48:477-487.

1. An anti-biofouling reaction product comprising a reaction product of at least one polymer, at least one metal chelating ligand comprised of at least one spacer arm side chain having at least one reactive affinity group, and at least one chelated metal ion moiety,
the reactive affinity group of the metal chelating ligand being complexed with and chemically bound to the chelated metal ion moiety,
the chelated metal ion moiety providing anti-biofouling properties to the reaction product without requiring loss of metal ions from the chelated metal ion moiety.

2. A filtration system comprising
an anti-biofouling reaction product comprised of at least one polymer, at least one metal chelating ligand comprised of a spacer arm side chain having a reactive affinity group, and at least one chelated metal ion moiety;
the reaction product chelating the metal ion into a matrix with the chelated metal ion moiety being incorporated into the matrix so that the filtration system can remove bio-fouling contaminants,
the chelated metal ion moiety providing anti-biofouling properties to the reaction product without requiring loss of metal ions from the chelated metal ion moiety.

3. A filtration system comprising a membrane and at least one feed spacer:
at least one feed spacer being comprised of an anti-biofouling reaction product; comprised of at least one polymer, at least one metal chelating ligand comprised of a spacer arm side chain having a reactive affinity group, and at least one chelated metal ion moiety,
the chelated metal ion moiety providing anti-biofouling properties to the reaction product without requiring loss of metal ions from the chelated metal ion moiety.

4. (canceled)

5. A filtration system comprising at least one filtration membrane, and one or more feed spacers comprised of, or coated with, an anti-biofouling reaction product of claim 1.

6. The anti-biofouling reaction product of claim 1, wherein the side chains are introduced on a main chain of the polymer by a graft polymerization method.

7. The anti-biofouling reaction product of claim 1, wherein the spacer arm side chain has an epoxy ring as the reactive moiety.

8. The anti-biofouling reaction product of claim 1, wherein the metal chelating ligand comprises a tridentate chelator.

9. The anti-biofouling reaction product of claim 1, wherein the metal chelating ligand comprises one or more of: iminodiacetic acid (IDA) and nitrilotriacetic acid.

10. The anti-biofouling reaction product of claim 1, wherein the affinity group moiety comprises a metal chelating ligand specific to one or more of: copper and silver.

11. The anti-biofouling reaction product of claim 1, wherein the polymer comprises a polypropylene.

12. The anti-biofouling reaction product of claim 1, wherein the spacer arm side chain comprises a vinyl monomer with an epoxy ring as the reactive moiety.

13. The anti-biofouling reaction product of claim 12, wherein the vinyl monomer is polymerized using an initiator.

14. The anti-biofouling reaction product of claim 12, wherein the vinyl monomer is copolymerized with other vinyl groups.

15. The anti-biofouling reaction product of claim 1, wherein the spacer arm side chain comprises glycidyl methacrylate (GMA).

16. The anti-biofouling reaction product of claim 1, wherein the metal ions comprise one or more of: silver, copper, and mixtures thereof.

17. The anti-biofouling reaction product of claim 1, wherein the polymer comprises one or more of: a film material and fibers, including woven fibers and unwoven fibers.

18. The anti-biofouling reaction product of claim 1, wherein the metal chelating ligand comprises iminodiacetic acid (IDA) and the spacer arm side chain comprises glycidyl methacrylate (GMA).

19. The filtration system of claim 3, wherein the feed spacer is in a reverse osmosis filtration device.

20. The anti-biofouling reaction product of claim 1, wherein the reaction product is formed as one or more of a: fiber, film or shaped article.

21. The anti-biofouling reaction product of claim 1, wherein the reaction product is dispersed as a coating.

22. Filtration devices for reverse osmosis spiral wound elements comprised of the anti-biofouling reaction product of claim 1.

23. A membrane system for biofouling control comprised of the anti-biofouling reaction product of claim 1.

24. A method for making an anti-biofouling polymer reaction product, comprising:
grafting spacer arm side chains onto a polymer, the spacer side arms having at least one reactive moiety;
introducing an affinity group moiety to at least one reactive moiety on the spacer arm side chain; and,
attaching anti-biofouling metal ions to the affinity group moieties, the metal ions providing anti-biofouling properties without requiring loss of metal ions from the affinity group moiety.

25. The method of claim 24, wherein the graft polymerization of the spacer arm side chain to polymer occurs without melting of the polymer.

26. The method of claim 24, wherein the graft polymerization of the spacer arm side chain to the polymer occurs at a temperature not greater than about 80° C.

27. The method of claim 24, wherein the affinity group moiety is added to the via an S_{N}2 reaction.

28. The method of claim 24, wherein the anti-biofouling metal ions are present in a copper sulfate solution.

29. The method of claim 24, wherein the anti-biofouling metal ion is in the form of an aqueous solution of a salt of the metal, comprising 0.25 to 15% w/w of the metal.

30. The method of claim 24, wherein benzoyl peroxide is used as a radical initiator for graft polymerization of the spacer arm side chains to the polymer.

31. (canceled)

32. A method for making anti-biofouling nanocomposite material, comprising:
i) using benzoyl peroxide (BPO) as a radical initiator for graft polymerization of glycidyl methacrylate (GMA) to polypropylene at a temperature of about 80° C.;
ii) adding iminodiacetic acid (IDA) to the polypropylene-graft-GMA of step i) via an S_{N}2 reaction; and
iii) placing the polypropylene-graft-GMA-IDA of step ii) in a copper sulfate solution for chelation of the copper ions.

33. The method of claim 32, wherein, in step iii), the polymer-graft-GMA-IDA is exposed to a 0.2 M copper sulfate solution for at least eight hours.

34. A method for making a functionalized polypropylene surface with metal affinity ligands, comprising:
i) activating a polypropylene backbone with a radical initiator;
ii) reacting the polypropylene of step i) with a spacer arm side chain having a reactive moiety;
iii) reacting the polypropylene of step ii) with a metal chelating affinity ligand; and
iv) exposing the polypropylene of step iii) to a copper sulfate solution for chelation of copper ions.

35. The method of claim 34, wherein the radical initiator comprises benzoyl peroxide.

36. The method of the claim 34, wherein the spacer arm side chain comprises glycidyl methacrylate (GMA).

37. The method of claim 34, wherein the metal chelating affinity ligand comprises iminodiacetic acid (IDA).

38. The method of claim 34, wherein the polypropylene of step iii) is exposed to a 0.2 M copper sulfate solution for about eight hours.

39. (canceled)

40. A device comprised of the anti-biofouling reaction product of claim 1.

41. A filtration system including one or more feed spacers comprised of the anti-biofouling reaction product of claim 1.

42. Liquid storage device comprised of the anti-biofouling reaction product of claim 1.

43. (canceled)

44. The device of claim 42, comprising one or more of: containers, tubing, specimen containers, water bottles, bottle stoppers, petri dishes, tubing/hoses, water storage, juice storage, wine storage, beer storage, and other fermented and/or purified materials.

45. A filtration device for reverse osmosis spiral wound elements comprised of the anti-biofouling reaction product of claim 1.

46. A membrane system for biofouling control comprised of the anti-biofouling reaction product of claim 1.
